(19) United States
(12) Patent Application Publication
(10) Pub. No.: US 2018/0138948 A1
(43) Pub. Date: May 17, 2018

(54) METHOD FOR ELECTRICALLY CHARGING AN ENERGY STORAGE UNIT OF A MOTOR VEHICLE, MOBILE OPERATING UNIT AND ENERGY SUPPLY FACILITY

(71) Applicant: AUDI AG, Ingolstadt (DE)

(72) Inventor: Ralph Hollmig, Ingolstadt (DE)

(73) Assignee: AUDI AG, Ingolstadt (DE)

(21) Appl. No.: 15/791,491

(22) Filed: Oct. 24, 2017

(30) Foreign Application Priority Data
Nov. 17, 2016 (DE) 10 2016 222 696.7

(51) Int. Cl. H04B 5/00; G06Q 20/32; G06Q 10/02; B60L 11/18

(52) U.S. Cl. CPC H04B 5/0031; H04B 5/0062; B60L 11/1846; G06Q 10/02; G06Q 20/3278

(57) ABSTRACT

A method for electrically charging an energy storage unit of a motor vehicle at a stationary energy supply facility. The following steps will be conducted for carrying out a payment process to pay for the electrical energy used for charging: creating a wireless communication link between a mobile operating unit and the energy supply facility; transmitting a payment request to the operating unit via the communication link and displaying the payment request on an image screen of the operating unit; detecting an identification feature by an input device for identifying a user through the operating unit and verifying successful identification by comparing the identification feature to a stored identification record; and upon successful identification, transmitting payment data to the energy supply facility via the communication link through the operating unit.

### FIELD

The invention relates to a method for electrically charging an energy storage unit of a motor vehicle at a stationary energy supply facility. In addition, the invention relates to a mobile operating unit as well as an energy supply facility.

### BACKGROUND

The motor vehicle provides the energy storage unit and an energy consumer, which can be operated by means of electrical energy that can be taken from the energy storage unit. The energy consumer is thus operated at least temporarily by means of electrical energy that is withdrawn from the energy storage unit. The energy consumer is an electrical machine, for example, in particular an electric motor, preferably a traction machine of the motor vehicle. In the latter case, the energy consumer or the electrical machine thus serves to drive the motor vehicle and in this regard, to supply a torque directed at driving the motor vehicle. The energy consumer in this case represents a drive assembly of the motor vehicle.

The energy consumer can be the only drive assembly of the motor vehicle. Of course, the motor vehicle can have at least one other drive assembly, however. The latter may also be present as an energy consumer or electrical machine that can be operated by means of the energy withdrawn from the energy storage unit. In this case, the motor vehicle is present, for example, as an electric motor vehicle or BEV (Battery Electric Vehicle). A configuration of the motor vehicle as a hybrid motor vehicle is also possible, however. In this case, the additional drive assembly is preferably a type other than the energy consumer or the drive assembly. Preferably, the additional drive assembly is then present as an internal combustion engine, or the like.

Electrical energy is withdrawn from the energy storage unit for operating the energy consumer and consequently this reduces its charging state. In particular, if the motor vehicle does not have another means for charging the energy storage unit, the energy storage unit must be charged from time to time at the energy supply facility. The energy supply facility is stationary, namely geodetically stationary, and is present, for example, in the form of a charging station, for example a charging column, or the like.

To pay for the electrical energy supplied by the energy supply facility or used for charging the energy storage unit, it can be provided that a driver of the motor vehicle identifies himself to the energy supply facility, in particular by using an identification means to be introduced at least in the vicinity of the energy supply facility or a reading device of the energy supply facility. An identification card or credit card or debit card can serve as such identification means. The latter can communicate to the energy supply facility by way of short-range communication, for example by means of RFID. It is usually provided, however, that the identification means must be brought into contact with the energy supply facility, for example, it must be inserted into the latter.

### SUMMARY

The object of the invention is to propose a method for electrically charging an energy storage unit of a motor vehicle at a stationary energy supply facility, which has advantages in comparison to known methods; in particular, it is more comfortable for the driver of the motor vehicle.

It is hereby provided that the following steps will be conducted for carrying out a payment process to pay for the electrical energy used for charging: creating a wireless communication link between a mobile operating unit and the energy supply facility; transmitting a payment request at the operating unit via the communication link and displaying the payment request on an image screen of the operating unit; detecting an identification feature by means of an input device for identifying a user through the operating unit and verifying successful identification by comparing the identification feature to a stored identification record; and upon successful identification, transmitting payment data to the energy supply facility via the communication link through the operating unit.

Therefore, first, the communication link is created between the operating unit and the energy supply facility. The communication link is wireless, thus is present, for example, as a radio communication link, optical communication link, or the like. The operating unit is mobile. This means that it is movable at least relative to the energy supply facility; for example, it is present as a component of the motor vehicle, for example as an operating console of the motor vehicle. The operating unit, however, can also, of course, be movable relative to the motor vehicle and/or its driver. In this case, for example it is configured as a portable operating unit that can be carried by the driver, for example, as a mobile phone, or the like.

The communication link is preferably initiated by the operating unit, so that the operating unit takes up the communication contact to the energy supply facility. On the contrary, an initiation of the communication link by the energy supply facility is also possible, of course.

After successfully creating the wireless communication link, the payment request is transmitted over it, that is, from the energy supply facility to the operating unit. The payment request contains, for example, information on the quantity of energy supplied or to be supplied by the energy supply facility, or the quantity of energy used or to be used for charging the energy storage unit, a price of the energy per quantity unit for the energy quantity, and/or a total price for the energy quantity. The payment request is displayed by the operating unit on its image screen and consequently is displayed to the driver of the motor vehicle or to a user of the operating unit.

After transmitting the payment request, the identification feature is detected by the operating unit, that is, with the use of the input device. The input device is preferably a component of the operating unit. The identification feature serves for identifying the user or the driver through the operating unit. The identification feature in this regard is a feature of the user or of the driver or a piece of information provided by the latter. After detecting the identification feature, the latter is compared with the stored identification record. The identification record is preferably stored in the operating unit. The identification record is thus not transmitted to the energy supply facility or intermediately stored by the latter, so that the identification of the user takes place only by means of the operating unit.

If the identification feature agrees with the identification record, then the identification is successful. If it does not, the identification fails, whereupon an error message is preferably given to the user. It can also be provided that in the case of a failed identification, a notification is issued to an owner or title-holder of the motor vehicle, in particular by way of another communication link, for example a cell phone connection, which is different from the communication link. Correspondingly, the failed identification is brought to the knowledge of the title-holder of the motor vehicle, preferably by transmitting positional data of a location of the motor vehicle of where it is located at the moment.

In contrast, upon successful identification, the payment data are transmitted to the energy supply facility, namely via the communication link. The payment data serves to pay for the electrical energy used. For example, the payment data thus includes a type of payment, an amount of payment, and/or a signature. The signature is preferably to be understood as a digital signature or electronic signature, which is based on a cryptographic method. The type of payment indicates, for example, the source of the funds used for payment, for example, giro card, credit card, debit card, payment service provider account, or the like. The payment amount is the total amount to be paid.

The actual charging of the energy storage unit with the energy supplied by the energy supply facility can be provided basically at any time point. For example, charging can occur prior to payment, thus particularly even before creating the wireless communication link. Also, payment can be provided during the payment process or after conclusion of the payment process, thus after transmitting the payment data to the energy supply facility. In the first case, the payment process is used to pay for the electrical energy actually expended for the charging of the energy storage unit. In the latter case, the amount of energy that will be maximally expended for charging will be communicated to the energy supply facility.

It may be provided that the communication link is produced by way of a short-range connection device. A wireless communication device that only works over short distances is to be understood as the short-range communication device. The short-range communication device is preferably present as a radio communication device. For example, the short-range communication device uses the Bluetooth standard.

In the scope of another embodiment of the invention, it is provided that the energy storage unit for charging is electrically connected, wired or wirelessly, to the energy supply facility. The connection between the energy storage unit and the energy supply facility that is used for the charging can be configured basically in any way; for example, it is wired or—preferably—wireless. In the latter case, there is thus no continuous cable connection between the energy storage unit and the energy supply facility, so that the connection is wireless, at least in segments or in route segments.

Another embodiment of the invention provides that the wireless connection of the energy storage unit to the energy supply facility is produced inductively. In this regard, the energy supply facility has a transmitter device for the inductive transmission of energy. In contrast, the motor vehicle has a receiver device for receiving the electrical energy sent by the transmitter device. For example, the transmitter device is arranged in such a way that the motor vehicle can be arranged over it. Thus, for example, the transmitter device is arranged in a roadway or lane that the motor vehicle can be driven up to.

A preferred embodiment of the invention provides that an operating unit attached to the motor vehicle or a portable operating unit is used as the operating unit. The operating unit attached to the motor vehicle is preferably the operating console of the motor vehicle, which has been mentioned above. The portable operating unit, in contrast, can be a mobile phone or the like.

Another preferred embodiment of the invention provides that the identification feature is detected by means of the input device designed as a fingerprint sensor, as a touch screen, and/or as a keyboard, in particular an input device attached to the motor vehicle. The input device can basically be configured in any way. For example, it is formed as attached to the motor vehicle or to the operating unit. This means that the input device can also be present independent from the operating unit.

For example, the input device is a component of the motor vehicle, whereas the operating unit is present as a portable operating unit, in particular as a mobile phone. This means that the operating unit makes use of the input device associated with the motor vehicle in order to query or to detect the identification feature of the user. The input device may be present, for example, as a fingerprint sensor, as a touch screen, or as a keyboard. Basically, of course, any configuration of the input device is possible.

An enhancement of the invention provides that a wireless identification link is produced from the portable operating unit to the input device that is attached to the motor vehicle. Such a configuration of the operating unit as well as the input device has already been discussed. The operating unit accesses the input device to detect the identification feature via the wireless identification link.

A preferred enhancement of the invention provides that the comparison of the identification feature with the identification record takes place in the operating unit. Therefore, the identification feature is present in all cases in the input device and the operating unit. Of course, it may be provided that the input device forms a component of the operating unit, so that the identification feature and the identification record do not leave the operating unit. In particular, a transmission of the identification feature and the identification record to the energy supply facility is not provided.

Finally, in the scope of another embodiment of the invention, it may be provided that the transmission of the payment request takes place before the energy storage unit is charged by the energy supply facility, wherein, after the transmission of the payment data, a specific energy quantity is transferred from the energy supply facility to the energy storage unit, or in that the transmission of the payment request takes place after the energy storage unit has been charged by the energy supply facility. Such a procedure has already been discussed above.

In addition, the invention relates to a mobile operating unit for carrying out a method for electrically charging an energy storage unit of a motor vehicle at a stationary energy supply facility. It is provided in this case that the operating device is designed for the purpose of carrying out the method according to the preceding statements for conducting a payment procedure to pay for the electrical energy used for the charging.

Finally, the invention relates to an energy supply facility for carrying out a method for electrically charging an energy storage unit of a motor vehicle at a stationary energy supply facility. It is provided thereby that the energy supply facility is designed for the purpose of carrying out the method according to the preceding statements for conducting a payment procedure to pay for the electrical energy used for the charging.

The advantages of such an embodiment of the operating unit, of the energy supply facility, and of the corresponding procedure have already been indicated. The operating unit, the energy supply facility, and also the method can be enhanced according to the above statements, so that in this regard, reference is made to the latter.

### BRIEF DESCRIPTION OF THE DRAWING

The invention will be explained in further detail in the following on the basis of the exemplary embodiments shown in the drawing, without resulting in any limitation of the invention.

FIG. 1 is a schematic representation of a motor vehicle as well as a stationary energy supply facility.

### DETAILED DESCRIPTION OF THE DRAWING

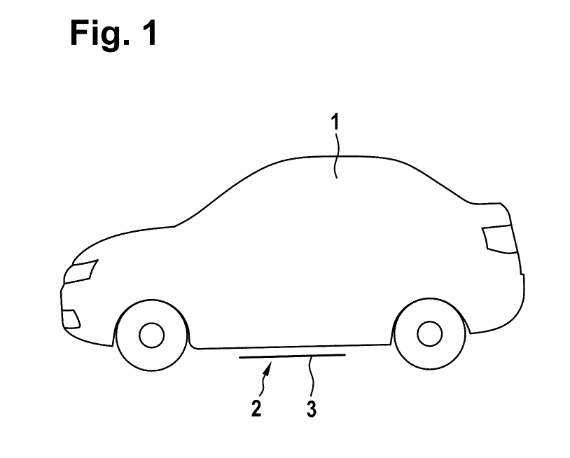

FIG. 1 shows a schematic representation of a motor vehicle 1 as well as an energy supply facility 2. Only a transmitter device 3 of the energy supply facility 2 can be recognized here, the transmitter device serving for the wireless transfer of electrical energy to the motor vehicle 1, in particular to a receiver device of the motor vehicle 1, which is not shown here. By using the energy supply facility 2, electrical energy for charging an energy storage unit of the motor vehicle 1 is supplied to the motor vehicle 1. The energy supply facility 2 can be disposed completely underground, in particular under a roadway or lane that the motor vehicle 1 can be driven up to. For example, it is only made known to a driver of the motor vehicle by means of above-ground markings.

Electrical energy is provided wirelessly by the energy supply facility 2 for the electrical charging of the energy storage unit of the motor vehicle 1. To pay for the electrical energy withdrawn for charging the energy storage unit, a payment process is carried out. The payment process proceeds as follows: first, a wireless communication link is created between a mobile operating unit, which is not shown here, and the energy supply facility 2. Subsequently, a payment request is transmitted to the operating unit, namely by the energy supply facility 2, via this communication link. This payment request is displayed on an image screen of the operating unit.

Subsequently, an identification feature of a user is provided by means of an input device. This serves for the identification of the user through the operating unit. The identification feature is compared to a stored identification record. The identification record is preferably stored exclusively in the operating unit. If the identification feature agrees with the identification record, then the identification of the user is successful. In this case, payment data are transmitted via the communication link from the operating unit to the energy supply facility. This payment data, for example, comprises a type of payment, a payment amount, and/or a signature, in particular, a signature of the user.

Employing such a procedure, the charging of the energy storage unit and, in particular, the payment of the quantity of energy used for this can take place in a particularly comfortable manner for the driver of the motor vehicle.

1. A method for the electrical charging of an energy storage unit of a motor vehicle at a stationary energy supply facility, comprising the following steps conducted for carrying out a payment process to pay for the electrical energy used for charging:
creating a wireless communication between a mobile operating unit and the energy supply facility;
transmitting a payment request at the operating unit via the communication link and displaying the payment request on an image screen of the operating unit;
detecting an identification feature by an input device for identifying a user through the operating unit and verifying successful identification by comparing the identification feature to a stored identification record; and
upon successful identification, transmitting payment data to the energy supply facility via the communication link through the operating unit.

2. The method according to claim 1, wherein the energy storage unit is electrically connected, wired or wirelessly, to the energy supply facility for the charging.

3. The method according to claim 2, wherein the wireless connection of the energy storage unit to the energy supply facility is produced inductively.

4. The method according to claim 1, wherein an operating unit attached to the motor vehicle or a portable operating unit is used as the operating unit.

5. The method according to claim 1, wherein the identification feature is detected by the input device designed as a fingerprint sensor, as a touch screen, and as a keyboard, wherein the input device attached to the motor vehicle.

6. The method according to claim 5, wherein a wireless identification link is produced from the portable operating unit to the input device that is attached to the motor vehicle.

7. The method according to claim 1, wherein the identification feature is compared to the identification record in the operating unit.

8. The method according to claim 1, wherein the payment request is transmitted before the energy storage unit is charged by the energy supply facility, wherein, after the transmission of the payment data, a specific energy quantity is transferred from the energy supply facility to the energy storage unit, or the payment request is transmitted after the energy storage unit has been charged by the energy supply facility.
